(19) United States
(12) Patent Application Publication
(10) Pub. No.: US 2024/0175693 A1
(43) Pub. Date: May 30, 2024

(54) EVACUATION ROUTE GUIDANCE SYSTEM, EVACUATION ROUTE CREATION METHOD, AND RECORDING MEDIUM RECORDING PROGRAM

(71) Applicant: NEC Corportion, Minato-ku, Tokyo (JP)

(72) Inventors: Nobuyuki TOZAWA, TOKYO (JP); Atsushi MATSUDA, TOKYO (JP); Kei YANAGISAWA, TOKYO (JP); Kosei KOBAYASHI, TOKYO (JP); Shouji HARUYAMA, TOKYO (JP)

(73) Assignee: NEC Corportion, Minato-ku, Tokyo (JP)

(21) Appl. No.: 18/282,090

(22) PCT Filed: Mar. 18, 2021
(86) PCT No.: PCT/JP2021/011039

§ 371 Date: Sep. 14, 2023

(51) Int. Cl. G01C 21/34; G06V 20/54

(52) U.S. Cl. CPC G01C 21/3461; G06V 20/54

(57) ABSTRACT

An evacuation route guidance system, which can respectively acquire one or more images shot by one or more cameras placed near roads of a target area, and a hazard map which includes locations of one or more dangerous places and locations of one or more safe areas in the target aera, including: a movement analysis part for analyzing movement of one or more moving bodies passing through a road in the target area based on one or more images shot by the one or more cameras at a time of occurrence of a disaster; a route creation part for creating a route adapted to movement of a moving body passing through the road, which route enables the moving body to move to a safe area by avoiding the one or more dangerous places; and a route output part for outputting the route to a predetermined display apparatus.

This application is a National Stage Entry of PCT/JP2021/011039 filed on Mar. 18, 2021, the contents of all of which are incorporated herein by reference, in their entirety.

### FIELD

The present invention relates to an evacuation route guidance system, an evacuation route creation method, and a recording medium recording a program.

### BACKGROUND

Patent Literature (PTL) 1 discloses a real-time hazard map system which can deal with an actual flood or overflow which varies from moment to moment. According to PTL 1, the real-time hazard map system has a function to acquire inundation and flood depth information (including underground malls) from inundation and flood depth sensors and flood status display means which provide flood status map (areas and locations, and water depth) by automatically drawing the contents on the map.
PTL 2 discloses an evacuation guidance system which can automatically grasp locations of target people who need to evacuate, and at the same time, guide the target people to an evacuation site by selecting a less dangerous evacuation route.
PTL 1: Japanese Patent Kokai Publication No: 2003-168179
PTL 2: Japanese Patent Kokai Publication No: 2005-17027

### SUMMARY

The following analysis has been made by the present inventors. Although local governments or the like provide a hazard map, each of residents currently moves to evacuation sites by judgement of each the residents. In the past, there have been a case in which a vehicle became undrivable as a result of forcibly moving a car in a flood caused heavy rain and a case in which vehicles are engulfed by tsunamis caused by earthquakes.

PTL 1 discloses that it is possible to display safe evacuation routes in the real-time hazard map system, but it is not assured that presented evacuation routes are always passable because a disaster varies from moment to moment. Conversely, it may become passable on foot because water has receded from a section which is judged to be flooded.

The evacuation guidance system of PTL 2 also creates an evacuation route by referring to danger information in a disaster related information database but it cannot necessarily create an optimum evacuation route at the occasions.

It is an object of the present invention to provide an evacuation route guidance system, an evacuation route creation method, and a recording medium recording a program which can provide an appropriate evacuation route based on a disaster situation in real-time.

According to a first aspect, there is provided an evacuation route guidance system, which can respectively acquire one or more images shot by one or more cameras placed near roads of a target area, and a hazard map which includes locations of one or more dangerous places and locations of one or more safe areas in the target aera, including: a movement analysis part for analyzing movement of one or more moving bodies passing through a road in the target area based on one or more images shot by the one or more cameras at a time of occurrence of a disaster: a route creation part for creating a route adapted to movement of a moving body passing through the road, which route enables the moving body to move to a safe area by avoiding the one or more dangerous places: and a route output part for outputting the route to a predetermined display apparatus.

According to a second aspect, there is provided an evacuation route creation method which is performed by a computer which can respectively acquire one or more images shot by one or more cameras placed near roads of a target area, and a hazard map which includes locations of one or more dangerous places and locations of one or more safe areas in the target aera. According to the evacuation route creation method, the computer analyzes movement of one or more moving bodies passing through a road in the target area based on one or more images shot by the one or more cameras at a time of occurrence of a disaster: creates a route adapted to movement of a moving body passing through the road, which route enables the moving body to move to a safe area by avoiding the one or more dangerous places: and outputs the route to a predetermined display apparatus. This method is associated with a certain machine, which is a computer which respectively acquires the one or more camera images and a hazard map.

According to a third aspect, there is provided a computer program (hereinafter, a “program”) for realizing the functions of the above evacuation route guidance system. This computer program is inputted to a computer apparatus via an input device or a communication interface from outside, is stored in a storage device, and drives a processor in accordance with predetermined steps or processing. In addition, this program can display, as needed, a processing result including an intermediate state per stage on a display device or can communicate with outside via the communication interface. As an example, the computer apparatus for this purpose typically includes a processor, a storage device, an input device, a communication interface, and as needed, a display device, which can be connected to each other via a bus. In addition, this program can be recorded in a computer-readable (non-transitory) storage medium. That is to say, the present invention can be realized by a computer program product.

According to the present disclosure, it is possible to provide an appropriate evacuation route based on a disaster situation in real-time.

### BRIEF DESCRIPTION OF DRAWINGS

FIG. 1 is a diagram illustrating a configuration according to an example embodiment of the present invention.

FIG. 2 is a diagram illustrating an operation according to the example embodiment of the present invention.

FIG. 3 is a diagram illustrating a configuration of an evacuation route guidance server according to a first example embodiment of the present invention.

FIG. 4 is a diagram illustrating an example of placement of fixed-point cameras according to the first example embodiment of the present invention.

FIG. 5 is a flow chart illustrating an operation of the evacuation route guidance server according to the first example embodiment of the present invention.

FIG. 6 is a diagram illustrating an operation of the evacuation route guidance server according to the first example embodiment of the present invention.

FIG. 7 is a diagram illustrating an operation of the evacuation route guidance server according to the first example embodiment of the present invention.

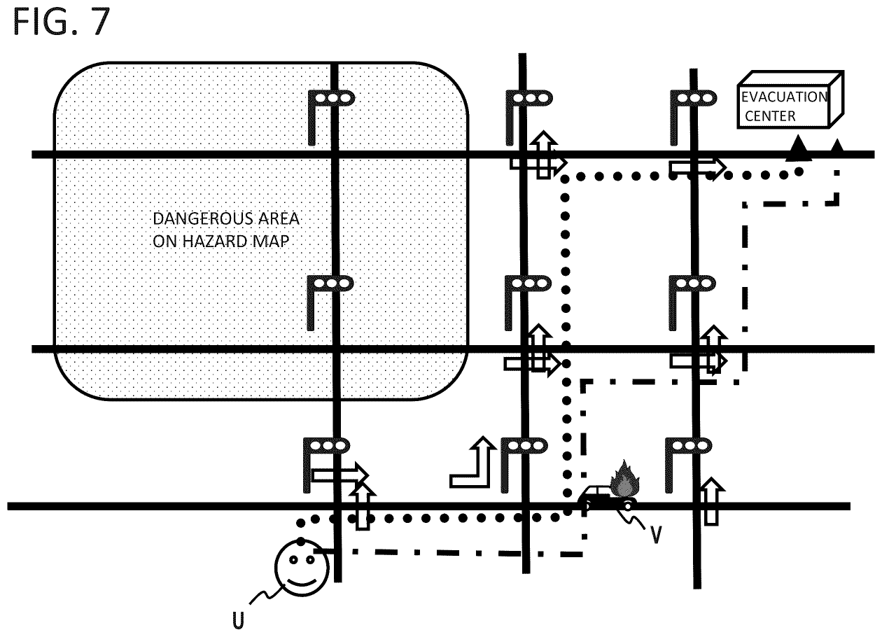

FIG. 8 is a diagram illustrating a configuration of an evacuation route guidance server according to a second example embodiment of the present invention.

FIG. 9 is a flow chart illustrating an operation of the evacuation route guidance server according to the second example embodiment of the present invention.

FIG. 10 is a diagram illustrating an operation of the evacuation route guidance server according to the second example embodiment of the present invention.

FIG. 11 is a diagram illustrating a configuration of an evacuation route guidance server according to a third example embodiment of the present invention.

FIG. 12 is a flow chart illustrating an operation of the evacuation route guidance server according to the third example embodiment of the present invention.

FIG. 13 is a diagram illustrating an operation of the evacuation route guidance server according to the third example embodiment of the present invention.

FIG. 14 is a diagram illustrating a configuration of an evacuation route guidance server according to a fourth example embodiment of the present invention.

FIG. 15 is a diagram illustrating an operation of the evacuation route guidance server according to the fourth example embodiment of the present invention.

FIG. 16 is a diagram illustrating an operation of the evacuation route guidance server according to the fourth example embodiment of the present invention.

FIG. 17 is a diagram illustrating a configuration of a computer which can function as an information provision server of the present invention.

### EXAMPLE EMBODIMENTS

First, an outline of an example embodiment of the present invention will be described with reference to drawings. Note, in the following outline, reference signs of the drawings are denoted to each element as an example for the sake of convenience to facilitate understanding and description of this outline is not intended to limit the present invention to any mode shown in the drawings or any limitation. An individual connection line between blocks in the drawings, etc., referred to in the following description includes both one-way and two-way directions. A one-way arrow schematically illustrates a principal signal (data) flow and does not exclude bidirectionality. In addition, although a port or an interface is present at an input/output connection point of an individual block in the relevant drawings, illustration of the port or the interface is omitted. A program is executed via a computer apparatus, and the computer apparatus includes, for example, a processor, a storage device, an input device, a communication interface, and as needed, a display device. In addition, this computer apparatus is configured such that the computer apparatus can communicate with its internal device or an external device (including a computer) via the communication interface in a wired or wireless manner. In addition, although a port or an interface is present at an input/output connection point of an individual block in the relevant drawings, illustration of the port or the interface is omitted.

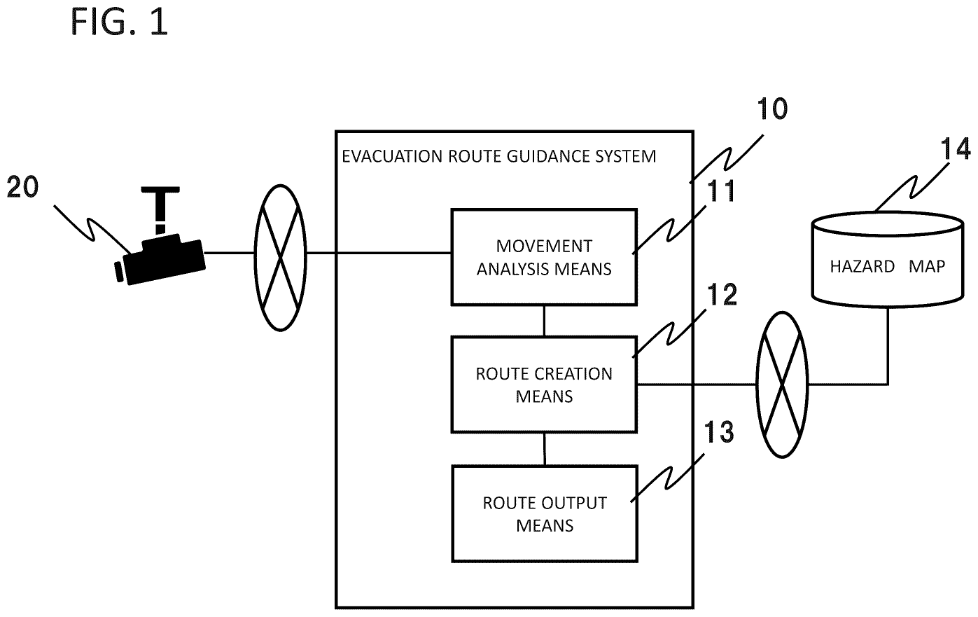

In an example embodiment, as illustrated in FIG. 1, the present invention can be realized by an evacuation route guidance system 10 which is configured to be able to respectively acquire one or more images shot by one or more cameras 20 placed near roads of a target area, and a hazard map 14. The hazard map 14 includes locations of one or more dangerous places and locations of one or more safe areas in the target aera.

The evacuation route guidance system 10 includes a movement analysis part 11, a route creation part 12, and route output part 13. More concretely, the movement analysis part 11 analyzes movement of one or more moving bodies passing through a road in the target area based on the one or more images shot by the one or more cameras at a time of occurrence of a disaster. The route creation part 12 creates a route adapted to movement of a moving body passing through the road, which route enables the moving body to move to the safe area by avoiding the one or more dangerous places. The route output part 13 outputs the route to a predetermined display apparatus.

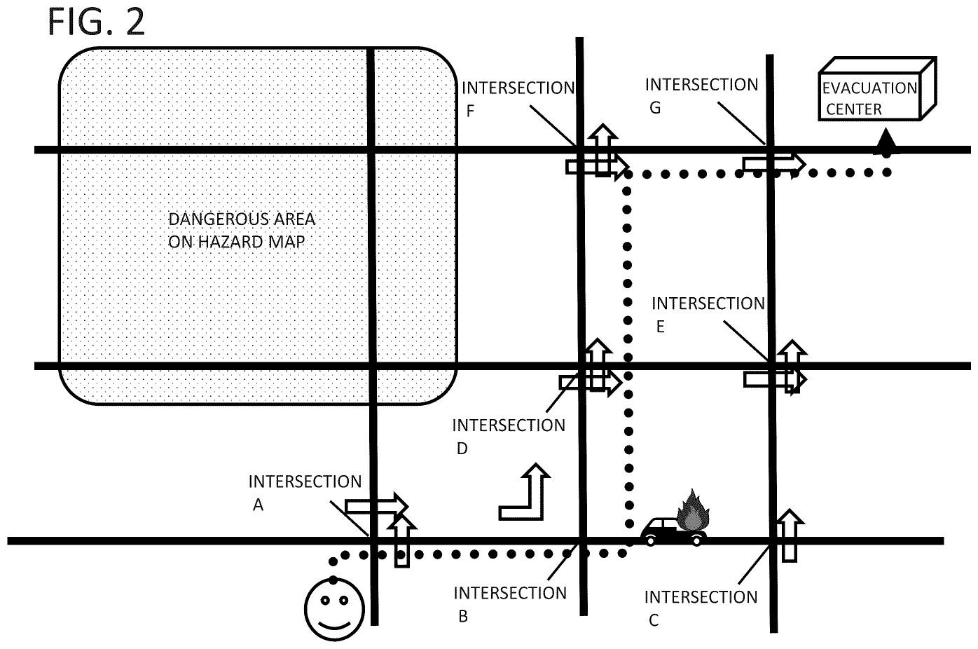

Next, an operation according to a present example embodiment will be described in detail with reference to FIG. 2. When a disaster occurs, the movement analysis part 11 analyzes movement of one or more moving bodies passing through a road in a target area based on one or more images shot by one or more cameras 20. In FIG. 2, open arrows show movement of one or more moving body passing through intersections. For example, in an example as shown in FIG. 2, because there is a burning vehicle between an intersection B and an intersection C whereby anyone cannot pass through between an intersection B and an intersection C, it is detected that one or more moving bodies moving from an intersection B toward an intersection B have turned left and are moving toward an intersection D.

On the other hand, the route creation part 12 creates a route adapted to movement of a moving body passing through the road, which route enables the moving body to move to the safe area by avoiding the one or more dangerous areas (dangerous places) of the hazard map 14. For example, as routes from an intersection A which is a user location to an evacuation center as one of the safe areas as shown in FIG. 2, there are at least 2 (two) routes one of which is a route via the intersection A an intersection B—an intersection C—an intersection E—an intersection G and another of which is a route via the intersection A—an intersection B—an intersection D—an intersection F—the intersection G. The route creation part 12 selects the route adapted to the movement of the moving body passing through the intersections from among 2 (two) routes, that is, the route via the intersection A—the intersection B—the intersection D—the intersection F—the intersection G.

Then, the route output part 13 outputs the route via the intersection A—the intersection B—the intersection D—the intersection F—the intersection G to a predetermined display apparatus to display. The route as displayed in this way is not only a route that enables the moving body to move to the safe area by avoiding the one or more dangerous areas (dangerous places) of the hazard map 14 but also a route adapted to the movement of the moving body passing through the road. As a result, the user can safely move from a current location to an evacuation center.

Note, the evacuation route guidance system 10 as described above can be realized, for example, by causing a smart phone, a mobile terminal or an on-board terminal or the like held by a user to execute a program which causes to realize each function as described above. That is, the evacuation route guidance system 10 can be realized as a smart phone, a mobile terminal, an on-board terminal or the like which have the functions as described above.

### First Example Embodiment

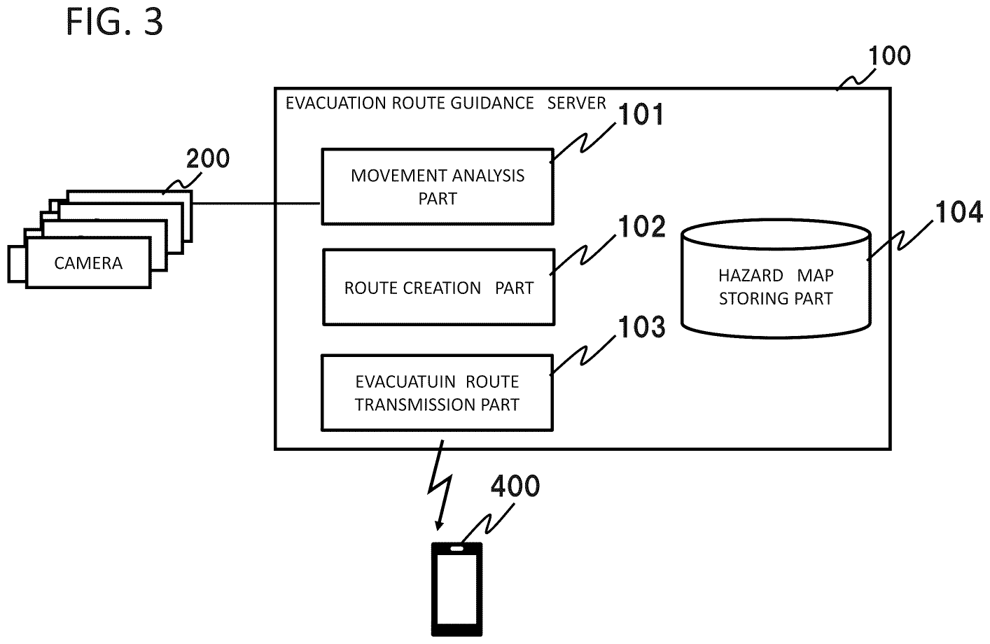

Next, a first example embodiment of the present invention will be described in detail with reference to drawings. FIG. 3 is a diagram illustrating a configuration of the first example embodiment of the present invention. With reference to FIG. 3, a configuration an evacuation route guidance server 100 which is connected to a plurality of cameras 200 is described. The evacuation route guidance server 100 includes a movement analysis part 101, a route creation part 102, an evacuation route transmission part 103, and a hazard map storing part 104. This evacuation route guidance server 100 can be realized by a server placed on a cloud platform or MEC (Multi-access Edge Computing) server placed near a service target aera.

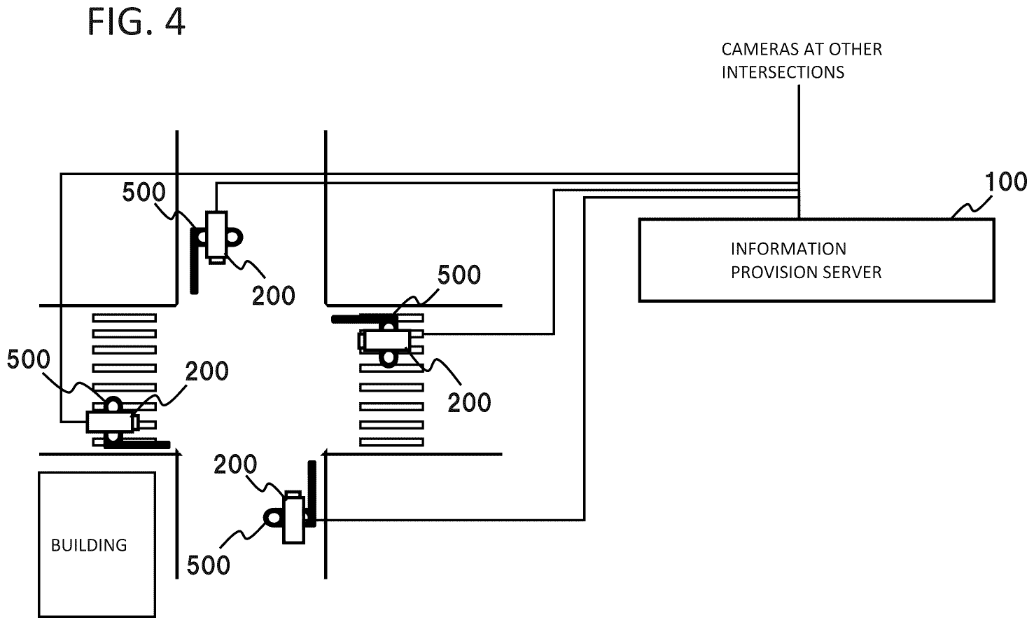

FIG. 4 is a diagram illustrating an example of placement of cameras 200 used for the first example embodiment of the present invention. The following example embodiment will be described by using cameras attached to traffic lights 500 as cameras 200 as shown in FIG. 4. One of advantages to use cameras attached to traffic lights 500 is that they can be placed in locations at which a traffic flow of intersections can be overviewed as shown in FIG. 4 and it is possible to divert existing power supplies and a communication part for existing signal control systems as their power supplies and communication part. Of course, as cameras 200, any camera placed at other roadsides can be used as well as the cameras 200 attached to traffic lights 500 as shown in FIG. 4

The movement analysis part 101 analyzes movement of one or more moving bodies passing through each intersection of the target area based on the one or more images shot by the one or more cameras 200 at a time of occurrence of a disaster. Note, as a moving body which is an analysis target, a vehicle or a pedestrian is considered. Movement of a moving body can be grasped using a method in such way that areas in an image in which a vehicle or a pedestrian exists are recognized and the movement of the moving body is grasped using sizes or movement of these areas in the image. In addition, as a method for recognizing areas in which a vehicle or a pedestrian exists in the image, a method using a classifier created by machine learning in advance can be used.

The hazard map storing part 104 stores a hazard map created by local governments based on records of past disasters and field investigations. Note, in the description of the present example embodiment, it is assumed that the hazard map includes locations of one or more dangerous places and locations of one or more safe areas, such as one or more evacuation centers, in the target area.

When a current location of a user or any start point is inputted, the route creation part 102 creates one or more routes which enable the moving body from the location to move toward a safe area, such as an evacuation center, by avoiding one or more dangerous places. In addition, the route creation part 102 creates an evacuation route by selecting a rout adapted to a moving body passing through the intersection from among the routes.

The evacuation route transmission part 103 transmits the evacuation route created by the route creation part 102 to terminate 400 held by a user.

The terminate 400 held by a user is a smart phone, a mobile terminal or an on-board terminal which can display the evacuation route transmitted from the evacuation route transmission part 103. Note, as a mode for transmitting an evacuation route from the evacuation route guidance server 100 to the terminal 400, one according to a function of a terminal may be selected. For example, when a terminal 400 is a smart phone, it is conceivable that route information is received from the evacuation route guidance server 100 by a function of an application (software) installed in the terminal 400. When a terminal 400 is an on-board terminal, it is conceivable that reflecting to a dynamic map, broadcasting from a base station installed as traffic infrastructure, or the like, in addition to the method as described above. Furthermore, the terminal 400 may be a terminal for information reception which is connected to a display panel and so on for traffic information.

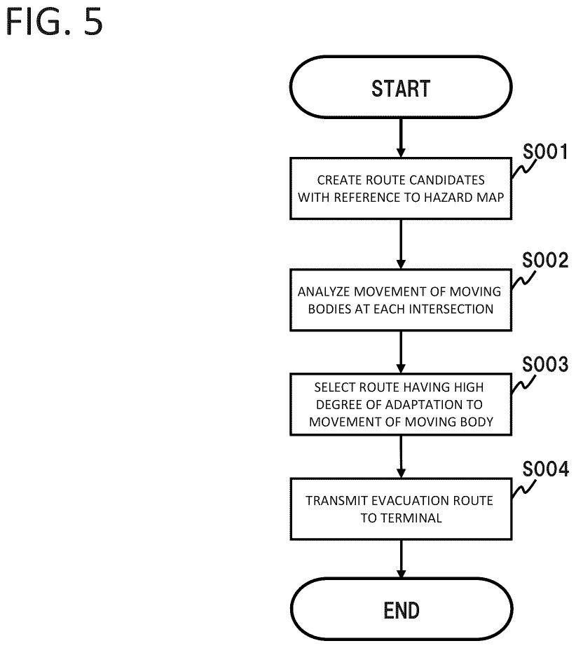

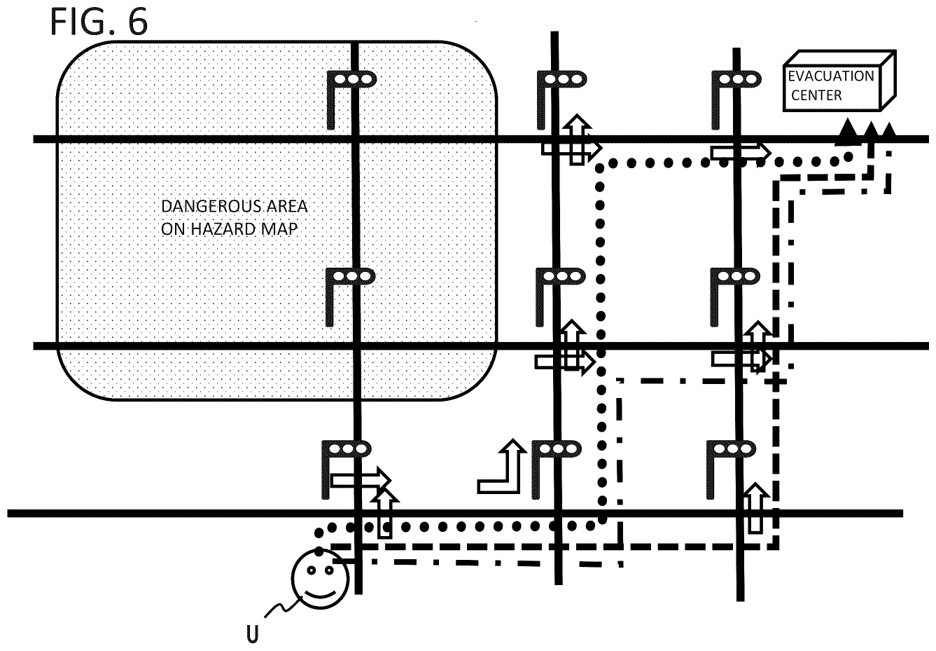

Next, the operation of the present example embodiments will be described in detail with reference to drawings. FIG. 5 is a flow chart illustrating an operation of the evacuation route guidance server 100 at a time of occurrence of a disaster according to the first example embodiment of the present invention. With reference to FIG. 5, first, the evacuation route guidance server 100 creates one or more routes from any start point to a location of a safe area such as an evacuation center by avoiding one or more dangerous places with reference to a hazard map (step S001). Note, as any start point, a current location of the terminal 400 which is a destination to transmit of evacuation route or a location designated by the terminal 400 may be used. Furthermore, as the current location of the terminal 400, a location acquired by a terminal position information acquisition part, such as GPS (Global Positioning System) and so on, may be used. For example, the evacuation route guidance server 100 may create 3 (three) routes from a current location of a user u to an evacuation center (a dashed line, a dotted line, and a dash-dot-dash line) as shown in FIG. 6.

Next, the evacuation route guidance server 100 analyzes movement of one or more moving bodies passing through each intersection in the target area based on the one or more images shot by the one or more cameras 200 (step S002). Here, for example, it is assumed that the evacuation route guidance server 100 has detected movement of one or more moving bodies denoted by open arrows at each intersection as shown in FIG. 6.

Next, the evacuation route guidance server 100 selects one or more routes which have high degree of adaptation to movement of a moving body from among the routes created in step S001 (step S003). Selection of the route is performed, for example, in such way that scores which indicate degree of adaptation to movement to the moving body analyzed in step S002 are respectively calculated for the routes created in step S001 and a route having high degree of the score is selected. For example, a route shown by a dashed line among 3 routes as shown in FIG. 3 includes a section which anyone cannot pass through due to a disabled vehicle V in the middle of the route. Therefore, because the route does not adapt to the movement of the moving body, the route is excluded from selection targets. As a result, an evacuation route adapted to the movement of the moving body passing through the intersections, which route enables the moving body to move to the safe area by avoiding the one or more dangerous places, is created.

Next, the evacuation route guidance server 100 transmits the created evacuation route to the terminal 400 held by the user (step S004).

As described above, according to the present example embodiment, it becomes possible to creates a route for enabling to actually move to a safe area such as an evacuation center or the like in addition to avoiding dangerous places on a hazard map and guide the route to a user. Note, in the example embodiment as described above, at a time of occurrence of a disaster, it is assumed that a present location of a user or any start point is inputted from a terminal 400 of a user or a communication carrier, a trigger of creation of an evacuation route is not limited thereto. For example, after receiving explicit transmission request of an evacuation route from a user, the evacuation route guidance server 100 may receive an input of a current location of a user or any start point and create an evacuation route. In this way, a user in distant place can acquire an evacuation route from the evacuation route guidance server 100 for the sake of a family in the area of a disaster.

Note, in the above description, after the evacuation route guidance server 100 has created one or more evacuation routes, movement of moving bodies passing through each intersection in the target area is analyzed. However, processings of steps S001 and S002 may be executed in parallel or an order of processings of step S001 and S002 may be exchanged and executed.

### Second Example Embodiment

Next, a second example embodiment in which movement of one or more moving bodies for each attribute is analyzed from one or more images shot by one or more cameras and a route for each attribute can be created will be described. Because a configuration and an operation of the second example embodiment are mostly common to those of the first example embodiment, a difference between them is mainly described below.

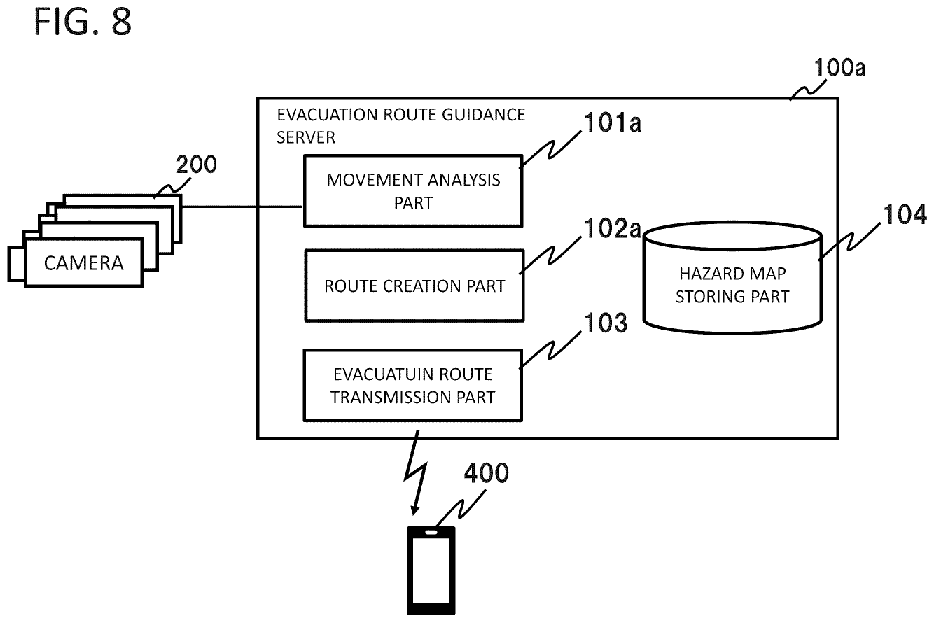

FIG. 8 is a block diagram illustrating a configuration of an evacuation route guidance server 100a according to the second example embodiment of the present invention. A difference from the evacuation route guidance server 100 according to the first example embodiment as shown in FIG. 3 is that a movement analysis part 101a of the evacuation route guidance server 100a analyzes movement of one or more moving bodies for each attribute and a route creation part 102a creates an evacuation route for each attribute. In the following description, an example in which an “attribute” of a moving body indicates a type of a moving body, such as a vehicle, a pedestrian, a bicycle or the like will be described.

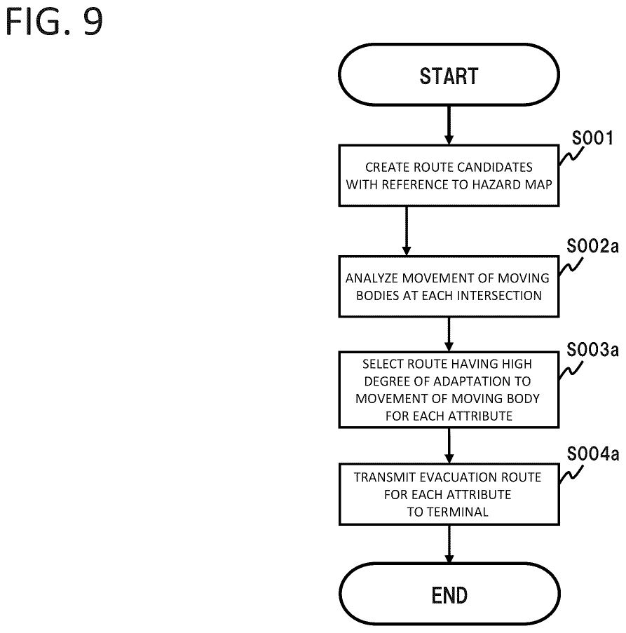

Next, an operation of the present example embodiment will be described in detail with reference to drawings. FIG. 9 is a flow chart illustrating an operation of the evacuation route guidance server 100a according to the present example embodiment. Because an operation of step S001 in FIG. 9 is the same as that of the first example embodiment, the description will be omitted.

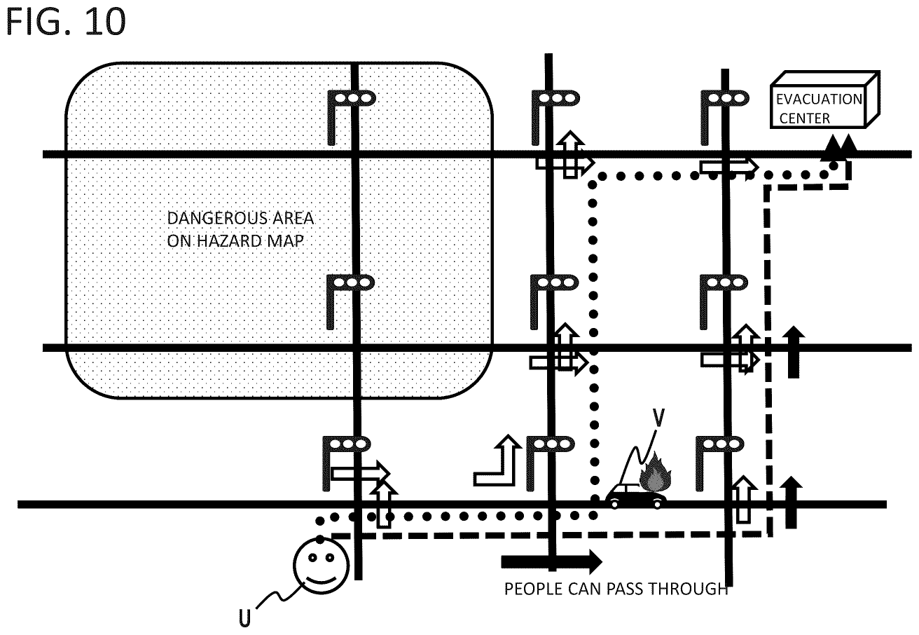

In step S002a, the evacuation route guidance server 100a analyzes movement of one or more moving bodies for each attribute passing through each intersection of the target area based on the one or more images shot by the one or more cameras 200. Here, for example, it is assumed that the evacuation route guidance server 100a has detected movement of one or more moving bodies denoted by open arrows and black bold arrows at each intersection as shown in FIG. 10. Here, it is assumed that open arrows in FIG. 10 indicate movement of one or more vehicles and black bold arrows indicate movement of one or more pedestrians.

In a step S003a, the evacuation route guidance server 100a selects, for each attribute, one or more routes which have high degree of adaptation to the movement of the moving body from among the routes created in step S001 (step S003a). For example, the evacuation route guidance server 100a selects a route shown by a dotted line of FIG. 10 as an evacuation route for a vehicle. Furthermore, the evacuation route guidance server 100a selects a route shown by a dashed line of FIG. 10 as an evacuation route for a pedestrian. This route for a pedestrian has selected based on an analysis result that a pedestrian can pass through a section in which a burning vehicle V exists, as a result of analysis of movement of one or more pedestrians as shown in FIG. 10.

Next, the evacuation route guidance server 100a transmits the created evacuation route for each attribute to a terminal 40 held by a user (step S004a).

As described above, according to the present example embodiment, it becomes possible to creates a route for enabling to actually move to an evacuation center by taking account of user attribute in addition to avoiding dangerous places on a hazard map and guide the route to a user. Particularly, in the present example embodiment, more optimal route can be guided in a case where a section in which a user of one attribute cannot pass through but a user of other attribute can pass through as shown in FIG. 10.

Note, in the above description, an example in which an “attribute” of a moving body indicates a type of a moving body, such as a vehicle, a pedestrian, a bicycle or the like has been described but the “attribute” of a moving body is not limited thereto. For example, for a pedestrian, “attribute” such as able-bodied person, a user of a wheeled chair, a user of sticks or the like are set and an evacuation route according to each attribute may be created. In the same way, for a vehicle, “attribute” such as a regular passenger car, a big-size car, a motor bike or the like are set and an evacuation route according to each attribute may be created.

### Third Example Embodiment

Next, a third example embodiment in which a moving velocity of one or more moving bodies and a number of one or more moving bodies are analyzed from one or more images shot by one or more cameras and an evacuation route is created will be described. Because a configuration and an operation of the third example embodiment are mostly common to those of the first example embodiment, a difference between them is mainly described.

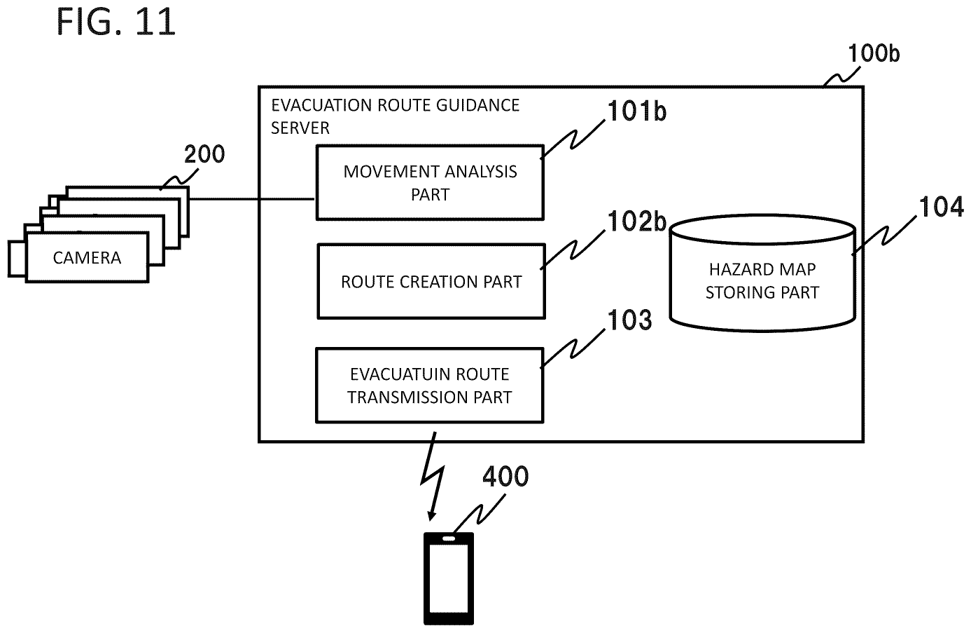

FIG. 11 is a block diagram illustrating a configuration of an evacuation route guidance server 100b according to the third example embodiment of the present invention. A difference from the evacuation route guidance server 100 according to the first example embodiment as shown in FIG. 3 is that a movement analysis part 101b of the evacuation route guidance server 100b analyzes a number of one or more moving bodies and a moving velocity of one or more moving bodies, and a route creation part 102b creates an evacuation route by taking account of them.

The movement analysis part 101b counts a number of one or more moving bodies passing through each intersection in a target area within a past predetermined time period based on one or more images shot by one or more cameras 200, at a time of occurrence of a disaster. The movement analysis part 101b calculates a moving velocity of one or more moving bodies passing through each intersection in a target area within the past predetermined time period based on the one or more images shot by the one or more cameras 200, at a time of occurrence of a disaster. Note, a moving velocity of an individual moving body can be calculated by acquiring a moved distance from a difference between a position within an image of the moving body in an image shot at a timing and a position within an image of the moving body in an image shot at a next timing. The movement analysis part 101b calculate a moving velocity of one or more moving bodies which have passed through each intersection in a target area within a past predetermined time period based on the moving velocities of the individual moving bodies. Note, as a moving velocity, for example, a value which is acquired by statistical processing of velocities of respective moving bodies within a predetermined time period, such as an average, a maximum value or a mode, can be used.

The route creation part 102b selects a route with reference to the number of the one or more moving bodies and the moving velocity of the one or more moving body when selecting a route adapted to movement of a moving body passing through the one or more intersections from among one or more routes toward the location of the safe area, such as the evacuation center as described above.

Concretely, if there are two or more routes each of which is a route toward the location of the safe area, such as the evacuation center as described above, and is adapted to movement of a moving body passing through the one or more intersections, the route creation part 102b selects a route with a larger number of the one or more moving bodies. Furthermore, if there are two or more routes each of which is a route toward the location of the safe area, such as the evacuation center as described above, and is adapted to movement of a moving body passing through the one or more intersections, the route creation part 102b selects a route with a larger moving velocity of the one or more moving bodies. Note, selection methods of a route are broadly classified as two types. One is a method for comparing a number of one or more moving bodies or a moving velocity of one or more moving bodies at the intersection of interest (which is a start point of different two routes). Another is a method for comparing a number of one or more moving bodies of all intersections on a route or a sum of moving velocities of one or more moving bodies. Calculation amount of the latter is larger than the former, it is possible to select a route easily to evacuate in total. Furthermore, when taking account of both a number of one or more moving bodies and a moving velocity of one or more moving bodies, any method can determine which route is selected by calculating a score for each route by weighting both of them and comparing both scores.

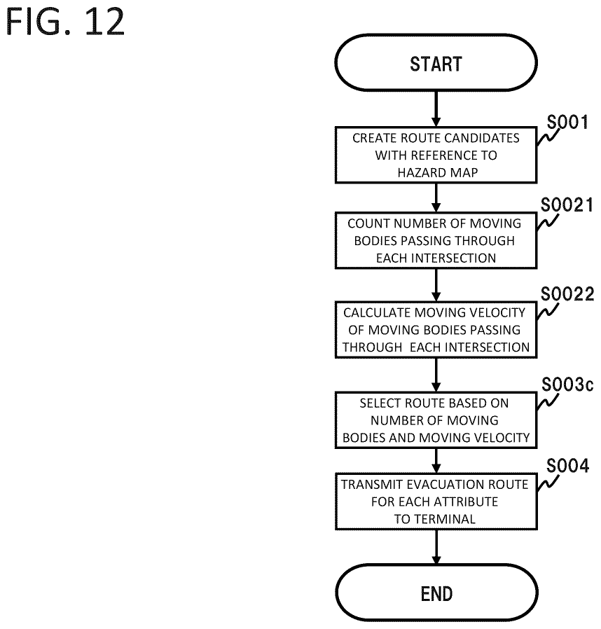

Next, an operation of the present example embodiment will be described in detail with reference to drawings. FIG. 12 is a flow chart illustrating an operation of the evacuation route guidance server 100b according to the present example embodiment. Because an operation of step S001 in FIG. 12 is the same as that of the first example embodiment, the description will be omitted.

In step S0021, the evacuation route guidance server 100b counts a number of one or more moving bodies passing through each intersection of a target area with reference to one or more images for a past predetermined time period shot by one or more cameras 200.

In next step S0022, the evacuation route guidance server 100b calculates a moving velocity of one or more moving bodies passing through each intersection in a target area with reference to one or more images for a past predetermined time period shot by one or more cameras 200.

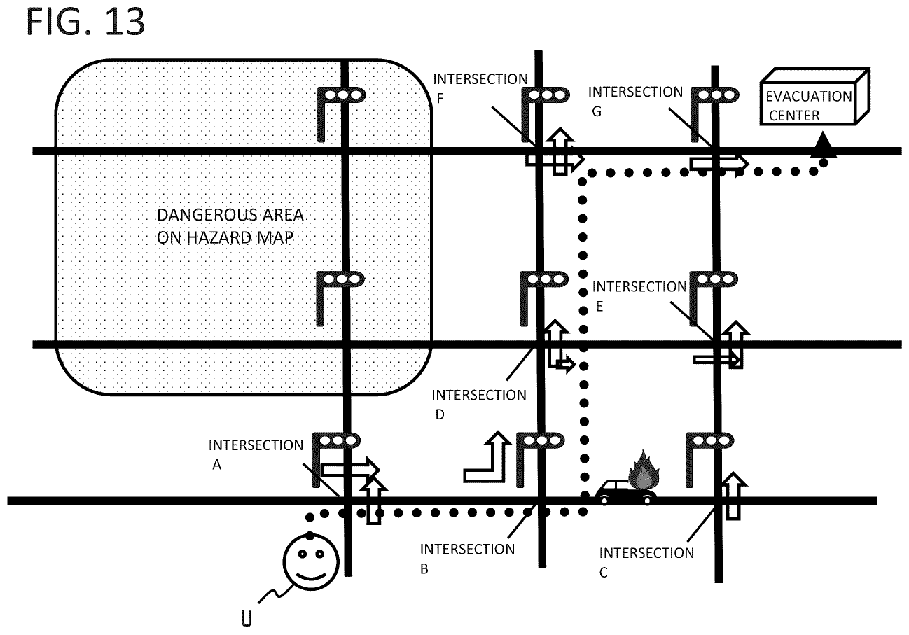

FIG. 13 is a diagram illustrating the number of the one or more moving bodies and the moving velocity acquired in steps S0021 and S0022 by open arrows. It is assumed that a width of arrow shown in FIG. 13 indicates the number of the one or more moving bodies and a length of arrow shown in FIG. 13 indicates the moving velocity of the one or more moving bodies. For example, at an intersection D shown in FIG. 13, there are an arrow toward an intersection E and an arrow toward an intersection F and the arrow toward the intersection F is longer and wider. This shows that the number of the moving bodies moved from the intersection D to the intersection F is more and the velocity thereof is faster.

Next, the evacuation route guidance server 100b selects a route which is adapted to the movement of the moving body passing through the intersection from among one or more routes which can move toward the safe area, such as the evacuation center as described above. At that time, the evacuation route guidance server 100b selects the route with reference to the number of one or more moving bodies and the moving velocity of one or more moving bodies (step S003c).

Concretely, the evacuation route guidance server 100b selects a route in which a number of one or more moving bodies having passed through each intersection is large and whose moving velocity is high. For example, in a case where there are 3 (three) routes form a current location of a user u to an evacuation center (a dashed line, a dotted line, and a dash-dot-dash line in FIG. 6), the evacuation route guidance server 100b selects a route with reference to a number of moving bodies having passed through each intersection and a moving velocity as shown in FIG. 13.

Finally, the evacuation route guidance server 100b transmits the created evacuation route to the terminal 400 held by the user (step S004).

As described above, according to the present example embodiment, it becomes possible to creates a route enabling to pass through easily and to evacuate fast in addition to avoiding dangerous places on a hazard map and guide the route to a user. The reason is that it is configured that a selection of a route is performed based on a number of one or more moving bodies having passed through each intersection in a target area and a moving velocity thereof.

Note, in the above description, it has been described that both a number of one or more moving bodies and a moving velocity thereof are calculated and selection of a route is performed based on them but a route may be selected by calculating either one of a number of one or more moving bodies or a moving velocity thereof.

Note, it is possible to enforce a combination of the third example embodiment and the second example embodiment as described above. In this case, both a number of moving body and a moving velocity thereof for each attribute are necessary to be calculated. By this, it becomes possible to creates a route enabling to pass through easily and to evacuate fast for each attribute, that is, an optimal evacuation route can be created, and the route can be guided to a user.

### Fourth Example Embodiment

Next, a fourth example embodiment in which a hazard map that is referred to according to a disaster which has occurred is switched will be described. Because a configuration and an operation of the fourth example embodiment are mostly common to those of the first example embodiment, a difference between them is mainly described.

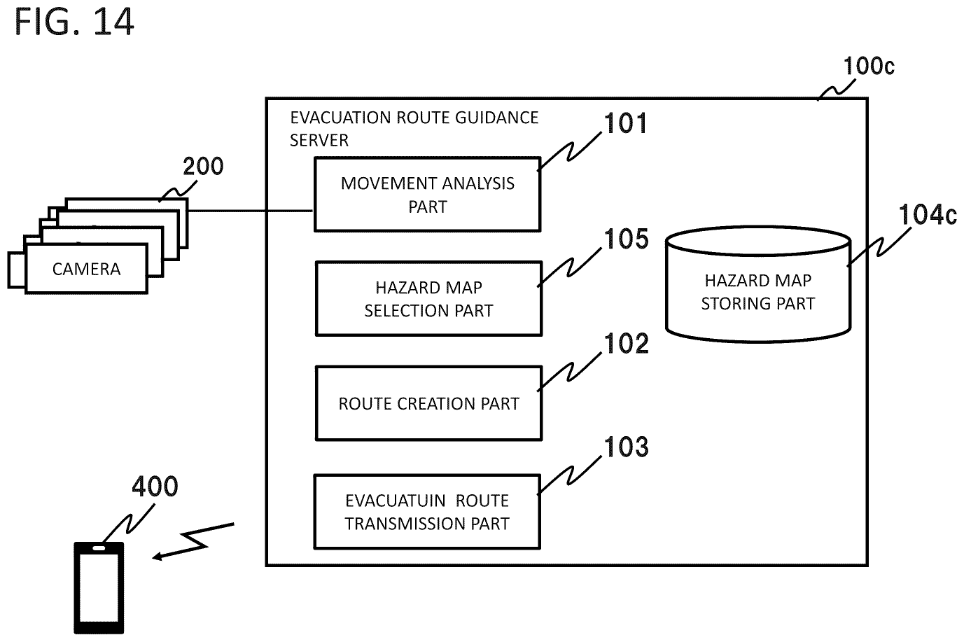

FIG. 14 is a block diagram illustrating a configuration of an evacuation route guidance server 100c according to the fourth example embodiment of the present invention. A first difference from the evacuation route guidance server 100 according to the first example embodiment as shown in FIG. 3 is that a hazard map storing part 104c stores a plurality of hazard maps according to types of disasters and size thereof in advance. A second difference between the evacuation route guidance server 100c and evacuation route guidance server 100 of the first example embodiment is that a hazard map selection part 105 is added to the evacuation route guidance server 100c.

The hazard map selection part 105 acquires a hazard map according to a type of a disaster and a size thereof from the hazard map storing part 104c at a time of occurrence of a disaster and passes the hazard map to the route creation part 102. Note, a type of a disaster and a size thereof may be acquired by disaster information, a news or the like transmitted from an agency, such as Meteorological Agency and so on, or the hazard map selection part 105 may judge a type of a disaster and a size thereof from one or more images of cameras 200.

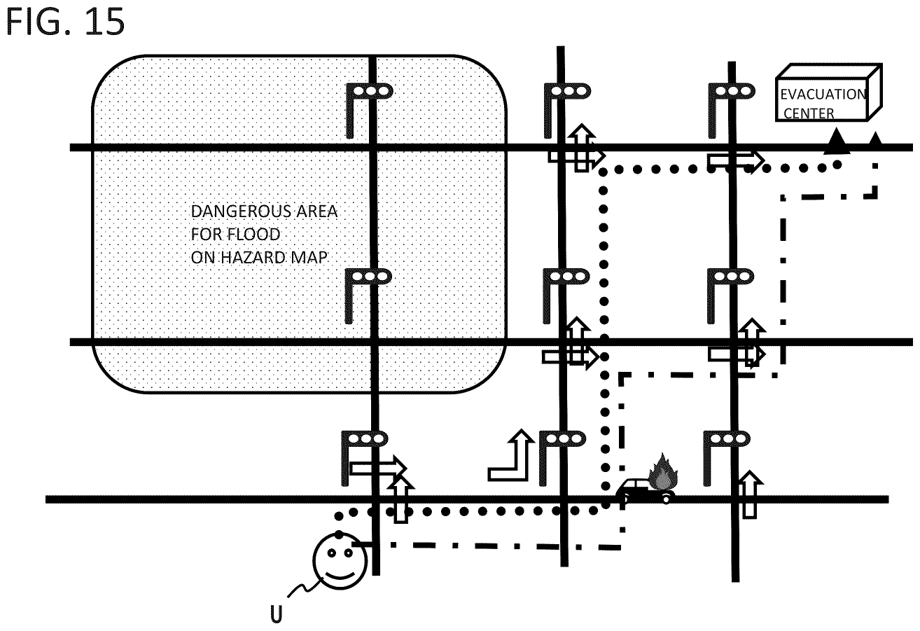

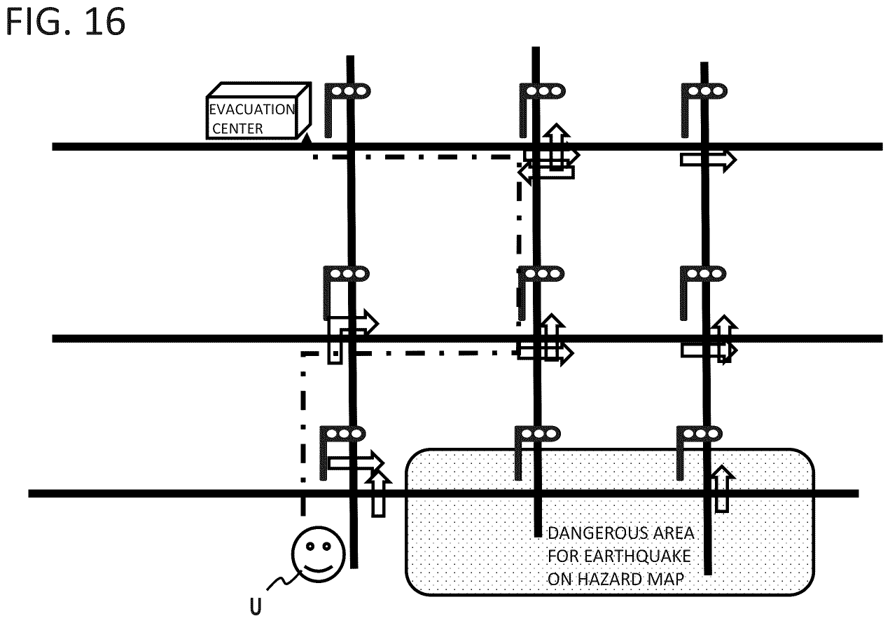

FIG. 15 is a diagram illustrating an example of a hazard map in a case where an occurred disaster is a flood and a route created by the evacuation route guidance server 100c. FIG. 16 is a diagram illustrating an example of a hazard map in a case where an occurred disaster is an earthquake and a route created by the evacuation route guidance server 100c. As described in FIG. 15 and FIG. 16, the dangerous places on a hazard map may vary according to a type of a disaster and a size thereof. Furthermore, a tall building having a high resistance against earthquake or a building in an area with low fire spread may be designated as an evacuation center in a case of an earthquake. A building in higher ground may be designated in a case of a flood. In the same way, even if a type of a disaster is the same, dangerous places and evacuation center may vary according to a size of degree. According to the present example embodiment, it becomes possible to guide an evacuation route according to a type of a disaster and a size thereof.

Note, it is possible to enforce a combination of the fourth example embodiment and the second and third example embodiments. In this case, an evacuation route may be created by taking account of an attribute of moving body and both a number of one or more moving bodies at each intersection and a moving velocity thereof.

The exemplary embodiments of the present invention have been described as above, however, the present invention is not limited thereto. Further modifications, substitutions, or adjustments can be made without departing from the basic technical concept of the present invention. For example, the configurations of the apparatuses and the elements and the representation modes of the data or the like illustrated in the individual drawings are merely used as examples to facilitate the understanding of the present invention. Thus, the present invention is not limited to the configurations illustrated in the drawings.

For example, in the example embodiment described above, it is described by assuming that an evacuation route guidance system can acquire movement of one or more moving bodies in a plurality of intersections in a target area. However, it is assumed that there is a case where it is difficult to install one or more cameras at a lot of intersections. In such a case, it may employ a configuration in which one or more camera images at intersections which are important points for evacuation in a target area may only be acquired. In such configuration, it is possible to create a safer evacuation route by analyzing movement of one or more moving bodies, selecting and creating a route based on analysis of movement.

For example, in the example embodiment as described above, it has been described that an evacuation route guidance system is configured by evacuation route guidance servers 100 to 100c. However, an evacuation route guidance system may be realized by a computer which can respectively acquire one or more images of cameras 200 and a hazard map. For example, by adding a function to acquire images of cameras 200 and a hazard map to a smart phone of a user or an on-board terminal, these apparatuses can configure an evacuation route guidance system only by themself.

Furthermore, in the example embodiments as described above, it has been described that evacuation route guidance servers 100 to 100c analyze movement of one or more moving bodies using one or more images of cameras 200. However, the evacuation route guidance servers 100 to 100c may be configured to analyze movement of one or more moving bodies by concurrently using other information. For example, a number of one or more moving bodies can be measured by using measurement of traffic flow or a sensor for monitoring congestion.

Furthermore, when an autonomous driving car or a mobile terminal with a position tracking function are included in moving bodies, a configuration in which movement in intersections directly is directly acquired from these moving bodies may be employed.

Furthermore, it has been described that a route is created by analyzing movement of one or more moving bodies, the evacuation route guidance servers 100 to 100c may create a route by using other information. For example, when cameras 200 can grasp that a condition of a road surface is bad, it may be understood that the section is impassable without analyzing movement of one or more moving bodies. In such case, the evacuation route guidance servers 100 to 100c can create a safe route by creating a route without using the section that a condition of a road surface is bad.

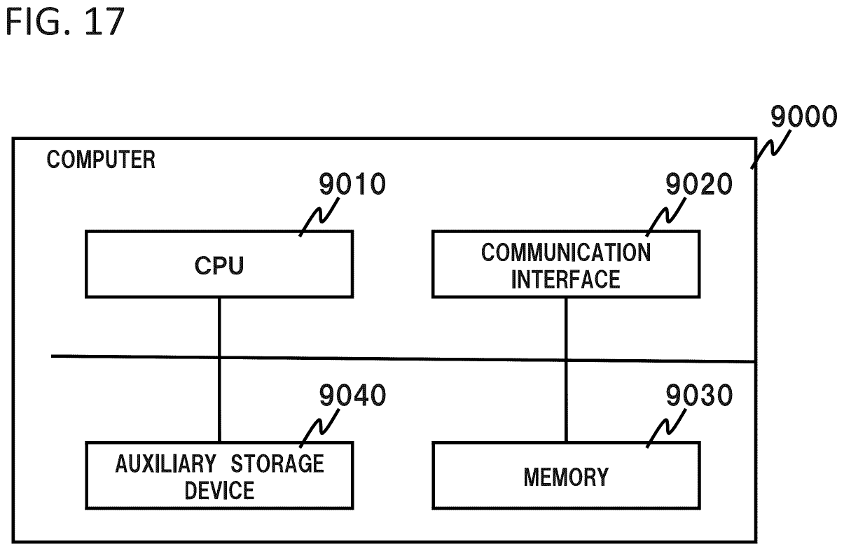

In addition, the procedures described in the above each example embodiment can each be realized by a program causing a computer (9000 in FIG. 17) functioning as the corresponding the evacuation route guidance servers to realize functions of the information provision servers. For example, this computer is configured to include a CPU (Central Processing Unit) 9010, a communication interface 9020, a memory 9030, and an auxiliary storage device 9040 in FIG. 17. That is, the CPU 9010 in FIG. 17 executes an image analysis program and a route creation program.

That is, the individual parts (processing means, functions) of each of the evacuation route guidance servers 100 to 100c as described above can each be realized by a computer program that causes a processor mounted on the corresponding apparatus to execute the corresponding processing described above by using corresponding hardware.

Finally, suitable modes of the present invention will be summarized.

### [Mode 1]

(See the evacuation route guidance system according to the above first aspect)

### [Mode 2]

The movement analysis part of the evacuation route guidance system as described above may have a configuration:
to analyze the movement of one or more moving bodies passing through one or more intersections of the target area based on the one or more images shot by the one or more cameras,
to analyze a number of one or more moving bodies passing through the one or more intersections based on the one or more images shot by the one or more cameras.

### [Mode 3]

The evacuation route guidance system as described above may have a configuration:
to analyze a number of one or more moving bodies passing through the one or more intersections based on the one or more images shot by one or more cameras, and
to create the route based on the number of one or more moving bodies passing through the intersection.

### [Mode 4]

The evacuation route guidance system as described above may have a configuration:
to create the route by giving a priority to a route having a large number of the one or more moving bodies passing through the one or more intersections.

### [Mode 5]

The evacuation route guidance system as described above may have a configuration:
to calculate a moving velocity of one or more moving bodies passing through the one or more intersections based on the one or more images shot by the one or more cameras, and
to create the route based on the moving velocity of one or more moving bodies passing through the one or more intersections.

### [Mode 6]

The evacuation route guidance system as described above may have a configuration:
to create the route by giving a priority to a route having a high moving velocity of one or more moving bodies passing through the one or more intersections.

### [Mode 7]

The evacuation route guidance system as described above may have a configuration:
to analyze movement of one or more moving bodies, for each attribute, passing through the one or more intersections based on the one or more images shot by the one or more cameras, and
to create, based on movement of a moving bodies for each attribute of a user of an evacuation route, the route for each attribute of the user.

### [Mode 8]

The route creation part of the evacuation route guidance system as described above may have a configuration:
to create the route by selecting a hazard map according to a disaster which has occurred from among a plurality of hazard maps for each type or each scale of a disaster.

### [Mode 9]

(See the evacuation route creation method according to the above second aspect)

### [Mode 10]

(See the program according to the above third aspect)

The above modes 9 and 10 can be expanded to the modes 2 to 8 in the same way as the mode 1 is expanded.

The disclosure of each of the above PTLs is incorporated herein by reference thereto and may be used as the basis or a part of the present invention, as needed. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be construed to have been concretely disclosed. In addition, as needed and based on the gist of the present invention, the individual disclosed matters in the above literatures, as a part of the disclosure of the present invention, and partial or entire use of the individual disclosed matters in the above literatures that have been referred to in combination with what is disclosed in the present application, should be deemed to be included in what is disclosed in the present application.

### REFERENCE SIGNS LIST

evacuation route guidance system
11 movement analysis part
12 route creation part
13 route output part
20, 200 camera
100, 100a to 100c evacuation route guidance server
101, 100a movement analysis part
102, 102a, 102b route creation part
103 evacuation route transmission part
104, 104c hazard map storing part
105 hazard map selection part
400 terminal
500 traffic lights
u user
V disabled vehicle
9000 computer
9010 CPU
9020 communication interface
9030 memory

What is claimed is:

1. An evacuation route guidance system, comprising:
at least a processor; and
a memory in circuit communication with the processor,
wherein the processor is configured to execute program instructions stored in the memory to perform:
acquiring one or more images shot by one or more cameras placed near roads of a target area;
acquiring a hazard map including locations of one or more dangerous places and locations of one or more safe areas in the target area;
analyzing movement of one or more moving bodies passing through a road in the target area based on one or more images shot by the one or more cameras at a time of occurrence of a disaster;
creating a route adapted to movement of a moving body passing through the road, the route enabling the moving body to move to a safe area by avoiding the one or more dangerous places; and
outputting the route to a predetermined display apparatus.

2. The evacuation route guidance system according to claim 1,
wherein the processor is further configured to execute program instructions to perform analyzing the movement of one or more moving bodies passing through one or more intersections of the target area based on the one or more images shot by the one or more cameras.

3. The evacuation route guidance system according to claim 2,
wherein the processor is further configured to execute program instructions to perform analyzing a number of one or more moving bodies passing through the one or more intersections based on the one or more images shot by the one or more cameras, and
wherein the processor is further configured to execute program instructions to perform creating the route based on the number of one or more moving bodies passing through the intersection.

4. The evacuation route guidance system according to claim 3,
wherein the processor is further configured to execute program instructions to perform creating the route by giving a priority to a route having a large number of the one or more moving bodies passing through the one or more intersections.

5. The evacuation route guidance system according to claim 2,
wherein the processor is further configured to execute program instructions to perform calculating a moving velocity of one or more moving bodies passing through the one or more intersections based on the one or more images shot by the one or more cameras, and
wherein the processor is further configured to execute program instructions to perform creating the route based on the moving velocity of one or more moving bodies passing through the one or more intersections.

6. The evacuation route guidance system according to claim 5,
wherein the processor is further configured to execute program instructions to perform creating the route by giving a priority to a route having a high moving velocity of one or more moving bodies passing through the one or more intersections.

7. The evacuation route guidance system according to claim 2,
wherein the processor is further configured to execute program instructions to perform analyzing movement of one or more moving bodies, for each attribute, passing through the one or more intersections based on the one or more images shot by the one or more cameras, and
wherein, the processor is further configured to execute program instructions to perform creating, based on movement of a moving bodies for each attribute of a user of a route, the route for each attribute of the user.

8. The evacuation route guidance system according to claim 1,
wherein the processor is further configured to execute program instructions to perform creating the route by selecting a hazard map according to a disaster which has occurred from among a plurality of hazard maps for each type or each scale of a disaster.

9. An evacuation route creation method, comprising:
by a computer,
acquiring one or more images shot by one or more cameras placed near roads of a target area;
acquiring a hazard map including locations of one or more dangerous places and locations of one or more safe areas in the target area;
analyzing movement of one or more moving bodies passing through a road in the target area based on one or more images shot by the one or more cameras at a time of occurrence of a disaster;
creating a route adapted to movement of a moving body passing through the road, which route enables the moving body to move to a safe area by avoiding the one or more dangerous places; and
outputting the route to a predetermined display apparatus.

10. A computer-readable non-transitory recording medium recording a program, the program causing a computer to perform processings of:
acquiring one or more images shot by one or more cameras placed near roads of a target area;
acquiring a hazard map including locations of one or more dangerous places and locations of one or more safe areas in the target area;
analyzing movement of one or more moving bodies passing through a road in the target area based on one or more images shot by the one or more cameras at a time of occurrence of a disaster;
creating a route adapted to movement of a moving body passing through the road, which route enables the moving body to move to a safe area by avoiding the one or more dangerous places; and
outputting the route to a predetermined display apparatus.

11. The evacuation route creation method according to claim 9,
wherein the computer analyzes the movement of one or more moving bodies passing through one or more intersections of the target area based on the one or more images shot by the one or more cameras.

12. The evacuation route creation method according to claim 11,
wherein the computer
analyzes a number of one or more moving bodies passing through the one or more intersections based on the one or more images shot by the one or more cameras, and
creates the route based on the number of one or more moving bodies passing through the intersection.

13. The evacuation route creation method according to claim 12,
wherein the computer creates the route by giving a priority to a route having a large number of the one or more moving bodies passing through the one or more intersections.

14. The evacuation route creation method according to claim 11,
wherein the computer
calculates a moving velocity of one or more moving bodies passing through the one or more intersections based on the one or more images shot by the one or more cameras, and
creates the route based on the moving velocity of one or more moving bodies passing through the one or more intersections.

15. The evacuation route creation method according to claim 14,
wherein the computer creates the route by giving a priority to a route having a high moving velocity of one or more moving bodies passing through the one or more intersections.

16. The recording medium according to claim 10,
wherein the program causes the computer to perform processings of:
analyzing the movement of one or more moving bodies passing through one or more intersections of the target area based on the one or more images shot by the one or more cameras.

17. The recording medium according to claim 16,
wherein the program causes the computer to perform processings of:
analyzing a number of one or more moving bodies passing through the one or more intersections based on the one or more images shot by the one or more cameras, and
creating the route based on the number of one or more moving bodies passing through the intersection.

18. The recording medium according to claim 17,
wherein the program causes the computer to perform processings of:
creating the route by giving a priority to a route having a large number of the one or more moving bodies passing through the one or more intersections.

19. The recording medium according to claim 16,
wherein the program causes the computer to perform processings of:
calculating a moving velocity of one or more moving bodies passing through the one or more intersections based on the one or more images shot by the one or more cameras, and
creating the route based on the moving velocity of one or more moving bodies passing through the one or more intersections.

20. The recording medium according to claim 19,
wherein the program causes the computer to perform processings of:
creating the route by giving a priority to a route having a high moving velocity of one or more moving bodies passing through the one or more intersections.
